(19) United States
(12) Patent Application Publication
(10) Pub. No.: US 2019/0044356 A1
(43) Pub. Date: Feb. 7, 2019

(54) BATTERY CHARGING AND BOOSTING DEVICE

(71) Applicant: Luke Lacasse, Medicine Hat (CA)

(72) Inventor: Luke Lacasse, Medicine Hat (CA)

(21) Appl. No.: 16/054,835

(22) Filed: Aug. 3, 2018

Related U.S. Application Data
(60) Provisional application No. 62/541,004, filed on Aug. 3, 2017.

(51) Int. Cl. H02J 7/00; H02J 7/02

(52) U.S. Cl. CPC H02J 7/0045; H02J 7/027; H02J 7/022

(57) ABSTRACT

A battery charging and boosting device which is directly mountable to a battery includes a bracket configured to mount the device to a battery; a primary module having an AC to DC converter connected to an AC current input and a primary trickle charge output adapted to connect to and charge the battery, and a booster cable connector; and a booster cable having a booster cable plug complementary to the booster cable connector of the primary module, and at an opposing end, either another booster cable plug or terminal clamps.

### FIELD OF THE INVENTION

The invention relates to a battery charger and booster.

### BACKGROUND

Batteries such as automotive or marine batteries frequently require charging to operate as intended. Occasionally, when the battery charge is depleted enough that it cannot operate the vehicle, it must be boosted by connection to another battery. Booster cables which connect to another battery, or booster batteries with integrated booster cables designed for such purposes are well known. However, such booster batteries or cables are separately stored and inconvenient to use. If improperly connected, they may pose a safety hazard.

Trickle chargers or battery maintainers which keep a battery charge topped up over extended periods of time are also well known. However, such chargers are also inconvenient to use as they require access to the battery, which is invariably located in the engine compartment or in a relatively inaccessible location. The charger itself is external to the vehicle.

There remains a need in the art for a battery charger and booster which may mitigate at least some of the above limitations in the prior art, or provide an alternative to prior art devices.

### SUMMARY OF THE INVENTION

The invention may comprise a modular battery charging and boosting device which is directly mountable to a battery, comprising:

(a) a bracket configured to mount the device to a battery;

(b) a primary module having an AC to DC converter connected to an AC current input and a primary trickle charge output adapted to connect to and charge the battery, and a booster cable connector; and

(c) a booster cable having a booster cable plug complementary to the booster cable connector of the primary module, and at an opposing end, either another booster cable plug or terminal clamps.

In another aspect, the invention may comprise a modular battery charging and boosting device which is directly mountable to a battery, comprising:

(a) a primary module having an AC to DC converter connected to an AC current input and a primary trickle charge output adapted to connect to and charge the battery, and a booster cable connector; and

(b) a booster cable having a booster cable plug complementary to the booster cable connector of the primary module, and at an opposing end, either another booster cable plug or terminal clamps;

wherein the device comprises an external form factor which mates with the form factor of the battery to form a substantially rectangular box.

In yet another aspect, the invention may comprise a battery defining a slot configured to receive a modular battery charging and boosting device, which device comprises a primary module having an AC to DC converter connected to an AC current input and a primary trickle charge output which directly connects to the battery, and a booster cable connector; and a booster cable having a booster cable plug complementary to the booster cable connector of the primary module, and at an opposing end, either another booster cable plug or terminal clamps; and wherein the combination of the battery and the primary module is a substantially rectangular box.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 is a schematic depiction of one embodiment of one aspect of the present invention,

FIG. 2A is top plan view of another embodiment. FIG. 2B is a side view of yet another embodiment.

FIG. 3 is side view of another embodiment.

FIG. 4 is cross-sectional view of the embodiment of FIG. 3 along line IV-IV.

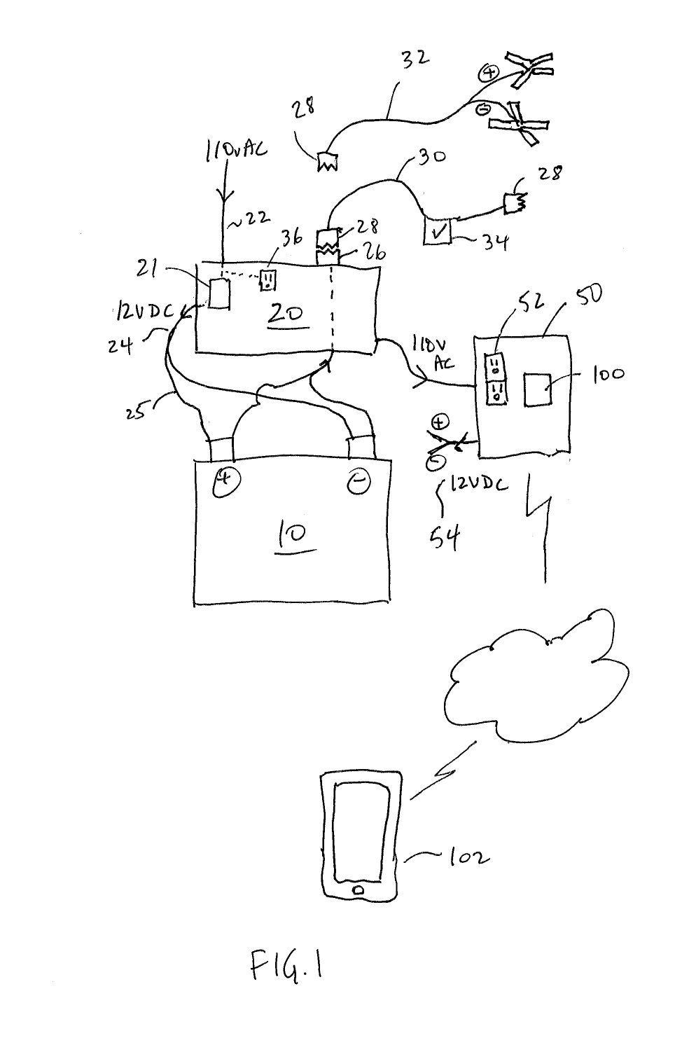

### DETAILED DESCRIPTION OF EMBODIMENTS OF THE INVENTION

In one aspect, the invention comprises a modular battery charging and boosting device which is directly mountable to a battery (10). In one embodiment, the device comprises:

(a) a bracket (15) configured to mount the device to a battery;

(b) a primary module (20) having an AC to DC converter (21) connected to an AC current input (22) and a primary trickle charge output (24) adapted to connect to and charge the battery, and a booster cable connector (26); and

(c) a booster cable (30) having a booster cable plug (28) complementary to the booster cable connector of the primary module, and at an opposing end, either another booster cable plug (28) or terminal clamps (32).

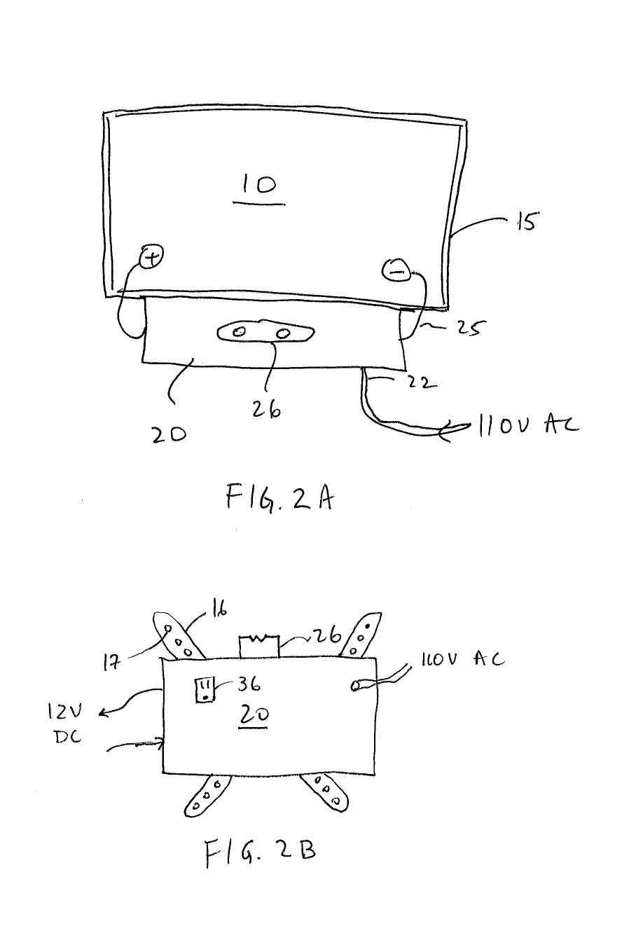

In one embodiment, the bracket (15) comprises a rigid or elastic sleeve which fits around the rectangular profile of the battery (10), as is shown in FIG. 2A. In an alternative embodiment, the primary module (0) may comprise an adapter bracket (16) which has multiple holes or openings (17) through which the bracket (16) may be mounted to various existing bolts or other fasteners in the vicinity of the battery (10)

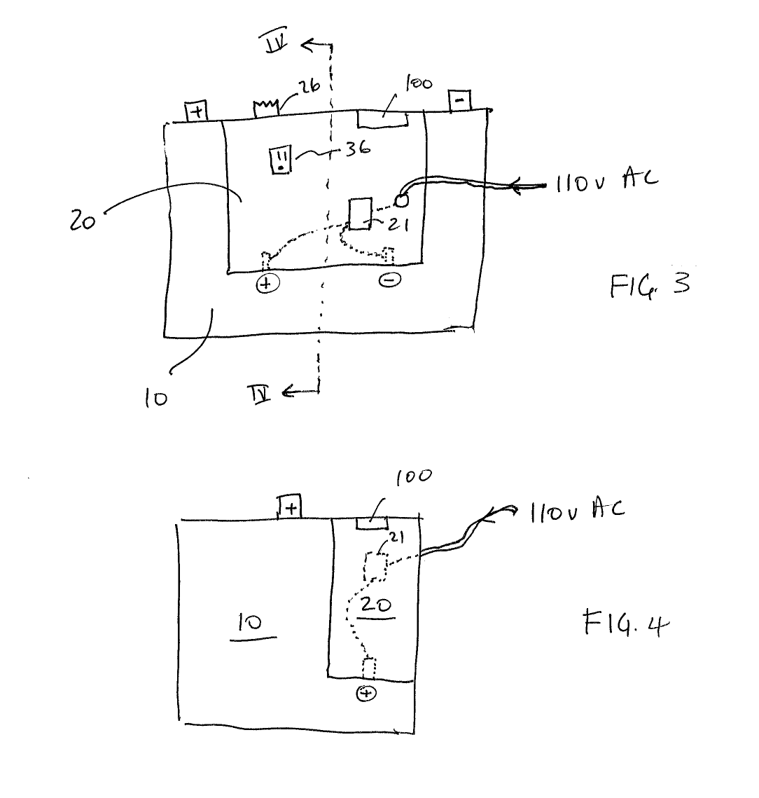

The trickle charge output (24) may connect to the battery (10) using conventional wires or cables (25), or may comprise a terminal-to-terminal connection, as shown in FIGS. 3 and 4 and described below. The trickle charge component may comprise circuitry which detects the state of charge of the battery and which monitors and controls the charging process, to prevent overcharging. In one embodiment, the primary module may comprise a state-of-charge meter, visible to a user.

In one embodiment, the booster cable connection (26) has a design which is complementary to a booster cable plug (28) on a booster cable (30). The booster cable (30) may be provided with the device as a kit, and have identical plugs (28) at both ends for use where the other vehicle has the same booster cable connector (26), or alternatively conventional clamps (32) to connect to a second battery terminals or posts.

The booster cable (30) may have a manually operated switch (34) with a polarity sensing circuit to verify the second batteries' polarity, before sending power to or receiving power from the second battery. The switch (34) may also include a visual indicator that the connections have the proper polarity, such as a light that glows green if the proper polarity is connected, or red if the polarity is incorrect.

The primary module (20) may also provide an AC outlet (36) which can be used for any auxiliary AC powered device.

In one embodiment, the device further comprises a secondary module (50) which mounts to the primary module (20) or to the battery (10), and which comprises at least one auxiliary AC outlet (52) connected to the AC input (22) of the control module, and a secondary trickle charge output (54). The secondary module (50) permits other AC accessories, such as a block heater, interior heater, and the like to be powered by the system without separate external plugs.

In a preferred embodiment, the device comprises a control and communication module (100) which comprises a processor operatively connected to the various inputs and outputs of either or both the primary and secondary modules, and which, in a preferred embodiment, may be controlled remotely by a user. The control and connection module (100) may comprise a communication system configured to connect with a user device (102) over a wireless network, such as by WiFi or a cellular network and/or over a Bluetooth or other short range wireless connection. The user device (102) may be configured to operate and automate certain functions, including turning on or off any switches, either manually or according to a schedule, and retrieve and view certain information, such as state-of-charge of the battery and confirmation of charging or boosting. In one embodiment, the user device may be configured to turn on and off the main AC outlet (36) or the auxiliary AC outlet (52).

In one embodiment, the battery (10) may comprise an external form factor which mates with the form factor of at least the primary module (20) to form a substantially rectangular box. The combination may be installable in standard vehicle configurations as a form factor similar to a conventional single battery. Preferably, the battery (10) comprises terminals which mate with male or female terminals on the primary module (20) and which align when the primary module is brought into engagement with the battery. For example, the battery (10) may define a slot into which the primary module (20) slides into, with male terminals disposed at the bottom of the slot which align with and connect into female terminals on the primary module.

The primary module (20) in this embodiment may include a control and communication module (100) which enables communication with a user device (102) as described above.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent terms of the functionality of the composition, or the embodiment.

1. A battery charging and boosting device which is directly mountable to a battery, comprising:
(a) a bracket configured to mount the device to a battery;
(b) a primary module having an AC to DC converter connected to an AC current input and a primary trickle charge output adapted to connect to and charge the battery, and a booster cable connector; and
(c) a booster cable having a booster cable plug complementary to the booster cable connector of the primary module, and at an opposing end, either another booster cable plug or terminal clamps.

2. The device of claim 1 wherein the bracket comprises a rigid or elastic sleeve which fits around the battery

3. The device of claim 1 wherein the bracket has multiple holes or openings through which the bracket may be mounted to various existing bolts or other fasteners in the vicinity of the battery.

4. The device of claim 1 wherein the trickle charge output is adapted to connect to the battery with wires cables or with a terminal-to-terminal connection

5. The device of claim 1 wherein the trickle charge component comprises circuitry which detects the state of charge of the battery and which monitors and controls the charging process.

6. The device of claim 1 wherein the primary module further comprises a state-of-charge meter, visible to a user.

7. The device of claim 1 wherein the booster cable connection is complementary to a booster cable plug on the booster cable.

8. The device of claim 7 wherein the booster cable comprises identical plugs at both ends, or battery clamps at one end to connect to second battery.

9. The device of claim 8 wherein the booster cable comprises a switch with a polarity sensing circuit to verify the second batteries' polarity, before sending power to or receiving power from the second battery.

10. The device of claim 9 wherein the switch comprises a visual indicator that the connections have the proper polarity.

11. The device of claim 1 wherein the primary module further comprises an AC outlet for powering any auxiliary AC powered device.

12. The device of claim 1 further comprising a secondary module which mounts to the primary module or to the battery, and which comprises at least one auxiliary AC outlet connected to the AC input of the primary module, and a secondary trickle charge output.

13. The device of claim 1 further comprising a control and communication module which comprises a processor operatively connected to the various inputs and outputs of one or both the primary and secondary modules.

14. The device of claim 13 wherein the control and communication module comprises a communication system for wireless communication with a user control device.

15. A battery charging and boosting device which is directly mountable to a battery, comprising:
(a) a primary module having an AC to DC converter connected to an AC current input and a primary trickle charge output adapted to connect to and charge the battery, and a booster cable connector; and
(b) a booster cable having a booster cable plug complementary to the booster cable connector of the primary module, and at an opposing end, either another booster cable plug or terminal clamps;
wherein the device comprises an external form factor which mates with the form factor of the battery to form a substantially rectangular box.

16. The device of claim 15 wherein primary module trickle charge output comprises male and female terminals which align with and connect to complementary terminals an the battery.

17. The device of claim 15 wherein the primary module comprises a control and communication module configured to communicate with a user control device to control the inputs and outputs of the primary module.

18. A battery defining a slot configured to receive a modular battery charging and boosting device, which device comprises a primary module having an AC to DC converter connected to an AC current input and a primary trickle charge output which directly connects to the battery, and a booster cable connector; and a booster cable having a booster cable plug complementary to the booster cable connector of the primary module, and at an opposing end, either another booster cable plug or terminal clamps; and wherein the combination of the battery and the primary module is a substantially rectangular box.
